(19) United States
(12) Patent Application Publication
(10) Pub. No.: US 2026/0227862 A1
(43) Pub. Date: Aug. 6, 2026

(54) PORTABLE DATA PROCESSING APPARATUS AND METHOD OF DETECTING A TARGET THEREWITH

(71) Applicant: ARSpectra S.à.r.l., Foetz (LU)

(72) Inventors: Cédric SPAAS, Foetz (LU); Augusto Wladimir DE LA CADENA, Foetz (LU); Serge GARBAY, Foetz (LU)

(21) Appl. No.: 19/151,135

(22) PCT Filed: Jan. 26, 2024
(86) PCT No.: PCT/EP2024/052006

§ 371 Date: Jul. 25, 2025

(30) Foreign Application Priority Data
Jan. 27, 2023 (LU) LU503395

(51) Int. Cl. G06F 3/01; G06V 40/20; H04N 23/667

(52) U.S. Cl. CPC G06F 3/017; G06V 40/28; H04N 23/667

(57) ABSTRACT

A portable or wearable data processing apparatus and a method of detecting a target with the apparatus are disclosed. The apparatus, for instance a head-mounted display device, comprises a data processing unit, at least one high-resolution imaging sensor operable to capture an environment ambient the apparatus in a field of view as image data, a low-resolution ranging sensor configured to detect one or more targets in the field of view within a distance interval of the apparatus, and optionally a display. The ranging sensor outputs target data encoding detected target characteristics upon detecting the or each target. The data processing unit receives at least the target data and filters targets therein by comparing the detected target characteristic with a target detection threshold. Filtered target data is mapped to a corresponding portion of the image data, when the imaging sensor captures the environment.

### FIELD OF INVENTION

The invention belongs to the field of portable or wearable data processing apparatuses equipped with imaging sensors and to the detection of targets in image data of environments ambient the apparatus, as captured by the sensors.

### BACKGROUND TO INVENTION

The tracking and identification of targets as visual cues is increasingly used for interaction with, and control of, portable and wearable electronic devices, such as smartphones and head mounted display (‘HMD’) devices, as an alternative to aural cues and physical haptic input or in addition thereto. HMD devices are digital display devices with data processing capacity either on-board or housed in a tethered companion module, which project digital video content in a user's direct field of view, either in superposition to the user's real physical environment in the case of see-through augmented reality (‘AR’) glasses, or in substitution thereof as computer-generated imagery in the case of virtual reality (‘VR’) headsets or still, lately, as a combination of captured physical environment and computer-generated imagery in the case of mixed reality (‘MR’) headsets.

Whether with HMDs or smartphones or the like, visual cues are detected and tracked optically, then analysed by the device to recognize a structure, for instance a limb or a hand in the context of gestural use interfaces, for translating into predefined device commands, e.g. “pinch” or “close”, with which to command the device's and/or a program's functionality. This form of interaction is of particular relevance to the medical field, wherein sterility requirements and the wearing of gloves often prevent users from using haptic input interfaces, such as touchscreens.

In order to recognize such visual cues in use, high-resolution image frames of the real physical environment that are captured by camera(s) of the HMD or similar device are input to an image analysis algorithm, which processes same to recognise one or more targets, e.g. one or both of the user's hands, present in the or each camera's field of view. The recognition is typically based upon computer vision or artificial intelligence principles, for example wherein a machine learning algorithm has been trained with a corpus of images depicting targets, e.g. various hand forming various command gestures, accounting for differences in target sizes, shapes, colours, environment brightness and illumination and more, e.g. the specific material reflection and colour of gloves when the intended context for use is medical.

A recent example of this technique is the open source MediaPipe® framework, which first detects a general area of each hand present in an image frame, then detects each actual hand within each such general area. This approach enhances the detection of hands and even articulated fingers, but still processes the whole image frame, which is of no interest in the specific context of gestural user interfaces and is therefore wasted data processing. A further disadvantage of this approach is that, subject to and within limits of an imaging sensor's optical resolution, the initial processing of the whole image frame detects all hands at any distance from the imaging sensor, thus including hands of any talent in an image frame, who is not the device's user but the framework may nevertheless still process and ultimately translate as a unintended command, i.e. “false positive” detections disrupting the intended use of the device.

Both computer vision and artificial intelligence approaches for target detection thus require significant computing resources, with correspondingly non-trivial power draw and processing time, moreover scaling up with the resolution of the image frames to analyse. These techniques process image data continuously for detecting targets substantially in realtime and their adaptation to and use by portable or wearable electronics, with limited onboard data processing capacity and battery power of limited autonomy by design, remains problematic.

### SUMMARY OF INVENTION

Aspects of the invention are set out in the accompanying claims, respectively aimed at various embodiments of a portable or wearable data processing apparatus, and various embodiments of a method of detecting a target with the apparatus.

In a first aspect, the present invention provides a portable data processing apparatus comprising data processing means, at least one high-resolution imaging sensor, operable to capture an environment ambient the apparatus in a field of view as image data; a low-resolution ranging sensor, configured to detect one or more targets in the field of view within a distance interval of the apparatus and to output target data encoding a detected target characteristic; and power storage means connected to supply the imaging sensor, the ranging sensor and data processing means, wherein the data processing means is configured to receive at least the target data from the ranging sensor, filter the received target data by comparing the detected target characteristic with a target detection threshold, and map the filtered target data to a corresponding portion of the image data, when capturing the environment with the or each high-resolution imaging sensor.

The low resolution ranging sensor in the apparatus of the invention advantageously provides the apparatus with a target pre-detection capacity, which removes the computational overhead associated with performing target recognition from computationally-expensive image processing, particularly in situations wherein proximate target recognition needs to be a permanent technical feature of the apparatus during use, such as for detecting hands within a gestural user interface. Targets present in the field of view beyond the distance interval, which would otherwise be detected and processed as false-positives in techniques of the prior art, are not detected and targets present in the field of view within the distance interval, with a detected target characteristic beyond the target detection threshold, are detected but filtered out, whereby the data processing means does not process corresponding image data and computational power is accordingly spared.

In certain embodiments of the apparatus wherein the detection is distance-based, the detected target characteristic comprises a distance between the detected target and the low-resolution ranging sensor, and the target detection threshold comprises a proximity threshold. In a variant further enhancing the accuracy of detection, the proximity threshold may be configurable to be less than the distance interval, whereby the data processing means filters received target data only when at least a first target reaches the proximity threshold within the distance interval. These configurations may be particularly useful when the apparatus, or an application program processed by same, is intended for use in an environment rich in potential targets at relatively close range from the apparatus.

Herein, a high-resolution imaging sensor should be understood as any camera or other light-based sensor, e.g. whether of the RGB, three dimensional time-of-flight (‘3D ToF’), thermal, near-infrared (‘NIR’) or events-based type, with an imaging resolution substantially higher than that of the ranging sensor, i.e. by a factor of least 10 and, correspondingly, substantially higher data output and power draw. In embodiments of the apparatus, the data processing means may be further configured to receive the image data from the high-resolution imaging sensor and to crop the corresponding portion from the received image data. Such embodiments usefully maintain the full resolution of the image data generated by the imaging sensor(s), particularly in terms of pixel density, but remove redundant image data from the image frame that will be passed to e.g. a gesture recognition algorithm of the prior art such as the MediaPipe® framework example, performing the initial hand area recognition on the basis of the partial image data cropped according to the target data supplied by the ranging sensor, rather than through a per-pixel analysis or other of the whole image frame with the data processing means.

In particularly power-efficient embodiments of the apparatus, the or each high-resolution imaging sensor may be switchable and triggered to capture image data only when a target is being detected. Accordingly, either the ranging sensor is preferably further configured to switch the imaging sensor upon outputting the target data, or the data processing means is preferably further configured to switch the imaging sensor upon receiving the target data. With such configurations, the power draw associated with operating the one or more full resolution imaging sensor(s) can be spared until a target is eventually validated. Such configurations are particular suited to augmented reality HMDs that let wearers observe the ambient environment through see-through lenses, wherein imaging of that environment is frequently redundant.

In embodiments of the apparatus, the ranging sensor may be configured to capture the field of view into a plurality of discrete zones by way of low resolution feature. Very low-resolution, low-power sensors of this configuration are known, inspired from single point detection sensors and which implement for instance an orthogonal array of discrete cells, e.g. a matrix of 8 by 8 or 16 by 16 cells. In such embodiments, wherein each cell is assigned a respective identifier, advantageously the target data may be as simple, as the respective identifier of a or each zone or cell corresponding to the target within the field of view, and the respective detected target characteristic for the or each such zone or cell.

Low-resolution ranging sensors for use with embodiments of the apparatus include a wide variety of sensor types, each preferably implementing a time-of-flight (ToF) technique and operably connected to the data processing means via a low-bandwidth data connection, for instance complying with the Inter-Integrated Circuit (I²C) protocol. In accordance with the principles explained hereinbefore, a low-resolution ranging sensor should be understood as any optical-, sound-or other wavelength-based sensor apt capable of measuring a distance to a target, with an resolution substantially lower than that of the imaging sensor, i.e. by a factor of least 10 and, correspondingly, substantially lower data output and power draw.

A field for which the invention is expected to be particularly beneficial, is gestural user interfaces, wherein the configuration and/or motion of an apparatus wearer's hand and/or digits is optically recognised and translated into data processing commands. Accordingly, embodiments of the apparatus may be specifically developed for use cases wherein the or each detectable target is a human hand, and wherein the corresponding portion comprises image data representative of the or each human hand. In such embodiments, the data processing means is preferably further configured to process the matched portion of image data into a user command.

In variants of such embodiments, when low resolution data from the ranging sensor encodes sufficient gestural information for translating into a user command, for example when the apparatus wearer moves a hand according to a specific direction corresponding to a specific user command, the data processing means may also, or instead, be further configured to process the target data into a user command. This further configuration usefully saves the data processing overhead associated with processing the portion of higher resolution image data into the same command.

In another aspect, the present invention provides a method of detecting a target with a portable data processing apparatus, the apparatus comprising data processing means, at least one high-resolution imaging sensor operable to capture an environment ambient the apparatus in a field of view as image data, a low-resolution ranging sensor configured to detect one or more targets in the field of view within a distance interval of the apparatus, and power means operably connected to the imaging sensor, the ranging sensor and the data processing means, the method comprising the steps of outputting target data encoding a detected target characteristic with the ranging sensor upon detecting the or each target, receiving at least the target data at the data processing means, filtering the received target data by comparing the detected target characteristic with a target detection threshold ; and mapping the filtered target data to a corresponding portion of the image data, when capturing the environment with the or each high-resolution imaging sensor.

In embodiments of the method, the detected target characteristic may comprise a distance between the detected target and the low-resolution ranging sensor, the target detection threshold may comprise a proximity threshold and the step of filtering further may further comprise comparing the distance between the detected target and the low-resolution ranging sensor with the proximity threshold to filter out target data distal the proximity threshold.

Embodiments of the method may comprise the further steps of capturing the environment with the high-resolution imaging sensor, outputting the image data captured to the data processing means and cropping the image data to the mapped portion with the data processing means.

In embodiments of the method, wherein the or each imaging sensor of the apparatus is switchable, the method preferably comprises the further step of switching the or each imaging sensor to capture when target data is either output by the low-resolution ranging sensor or received by the data processing means.

In embodiments of the method, the step of outputting the target data may further comprise dividing the field of view into discrete zones at the ranging sensor, whereby the target data may be a respective identifier of a or each zone.

In embodiments of the method particularly aimed at gestural user interfaces, wherein the or each target is a human hand and the corresponding portion comprises image data representative of the or each human hand, the method preferably comprises the further step of processing the corresponding portion of image data, alternatively the target data itself if it encodes sufficient contextual information, into a user command with the data processing means.

The invention is particularly aimed at detecting targets proximate to the apparatus, accordingly the distance interval may be in the range 10 to 400 centimetres, or even less, for example 30 to 70 centimetres to help mitigate against false positive detections.

Other aspects of the invention are set out in the accompanying claims.

### BRIEF DESCRIPTION OF DRAWINGS

The invention will be more clearly understood from the following description of an embodiment thereof, given by way of example only, with reference to the accompanying drawings, in which:

FIG. 1 illustrates a portable apparatus of the prior art, in the example a head mounted display (HMD) apparatus with a full resolution imaging sensor, and a method of detecting targets with same according to the prior art.

FIGS. 2A, 2B and 2C show respective embodiments of a wearable apparatus according to the invention, in the example a HMD device with a low power ranging sensor and one or more full resolution imaging sensor(s).

FIGS. 3A and 3B are functional diagrams of example hardware architectures for the HMD devices shown in FIGS. 2A to 2C, each including a memory.

FIG. 4 shows a user wearing a HMD of any of FIGS. 2A to 3B and illustrates the respective fields of view of the imaging and ranging sensors shown in FIGS. 2A to 3B.

FIG. 5 illustrates a full resolution image frame and a low resolution detection array corresponding to the respective fields of view shown in FIG. 4.

FIG. 6A details data processing steps performed by the low power ranging sensor of FIGS. 2A to 4 to populate the array of FIG. 5.

FIG. 6B details optional data processing steps performed by the low power ranging sensor, additional to those of FIG. 6A.

FIG. 7A details data processing steps performed by an apparatus of FIG. 2A to 6A or 6B.

FIG. 7B details optional data processing steps performed by the apparatus, additional to those of FIG. 7A.

FIG. 8 illustrates the contents of the memory of FIG. 3A or 3B at runtime when performing the steps of FIG. 7A or 7B.

FIG. 9 shows the full resolution image frame and low resolution detection array of FIG. 4 according to data processing steps performed by an apparatus of FIG. 2A to 6A or 6B in an alternative embodiment.

FIG. 10 details data processing steps performed by an apparatus of FIG. 2A to 6A or 6B according to an alternative embodiment, wherein target data of the ranging sensor is processed into motion and/or directional data.

### DETAILED DESCRIPTION OF DRAWINGS

There will now be described by way of example specific modes contemplated by the inventor. In the following description and accompanying figures, numerous specific details are set forth in order to provide a thorough understanding, wherein like reference numerals designate like features. It will be readily apparent to one skilled in the art, that the present invention may be practiced without limitation to these specific details. In other instances, well known methods and structures have not been described in detail, to avoid obscuring the description unnecessarily.

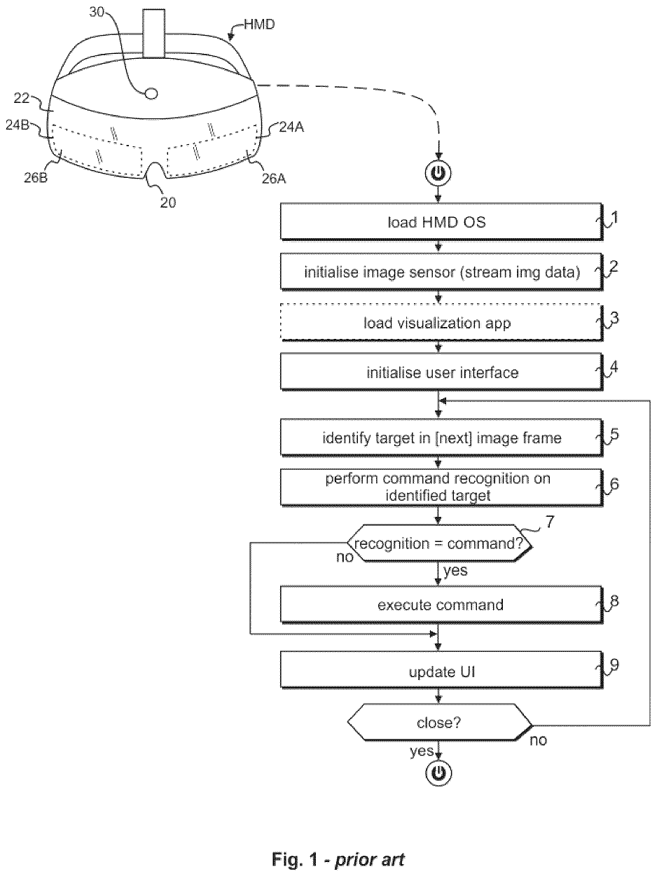

With reference to FIG. 1, a portable data processing apparatus of the prior art, in the example an augmented reality (‘AR’) head mounted display (‘HMD’) device is shown together with a prior art method of detecting targets with the device. The AR HMD comprises a wearer visor 20, which includes a main see-though portion 22 and eye-respective video display portions 24A, 24B located equidistantly of a central bridge portion overlying a wearer's nose in use.

The display portions 24A, 24B implement, perceptually, a single video display occupying a subset of the front aspect of the HMD, wherein the wearer can observe both the ambient physical environment and the display. Each video display portion 24A, 24B consists of a respective video display unit 26A, 26B, in the example a micro OLED panel with a minimum 60 Hz frame refresh rate and a resolution of 1920×1080 pixels, located proximate a lower edge of the visor so as to leave the see-though portion 22 extending above it and up to its upper edge, clear of visual occlusion when the VDUs are displaying.

The HMD further comprises a high resolution optical sensor 30, which captures visible light in a wavelength range of typically 400 to 700 nm in its field of view of typically 70 to 90 degrees, and outputs image data as a sequence of RGB image frames, at a resolution of 1920×1080 pixels at least, and at a rate of 60 frames per second or more.

At powering time, the HMD initially loads firmware and an operating system (‘OS’) at step 1, then initialises the imaging sensor 30 at step 2, then optionally loads an application program for additional data processing functionality at step 3, for example processing and rendering information to a user interface initialised at step 4 and output to the VDUs 26A, 26B. In the absence of the optional application program at step 3, the HMD still initialises a user interface for the OS at step 4.

The image data generated by the imaging sensor 30 as of step 3 is continuously input to a target detection algorithm, which may be a subroutine of either the OS and/or the optional application program, wherein each high resolution image frame is fully processed, i.e. traversed, by the algorithm to identify one or more targets therein, e.g. a hand of the HMD wearer, at step 5, for instance in the first stage of the MediaPipe® prior art technique. Upon successfully detecting at least one target, the HMD proceeds to recognise whether the identified target encodes a command at step 6, for instance in the second stage of the MediaPipe® prior art technique. A question is accordingly asked at step 7, about whether a command has been recognised. In the affirmative, the OS or the optional application program executes the corresponding data processing command step 8. Immediately thereafter, the HMD updates the user interface of step 4, likewise when the question of step 7 is answered negatively. A next question is then asked, about whether the HMD should be powered down, alternatively whether the optional application program should be terminated and unloaded from memory, which is answered negatively whilever the HMD remains in use, whereby control return to the identification of step 5 in a next image frame from the imaging sensor 30, and so on and so forth.

Given the prior art context described with reference to FIG. 1, the inventors considered that image data to process for target recognition and translation with augmented reality (AR) HMDs and similarly low-powered electronic devices should be as small as possible. The inventors also observed that decreasing the image data resolution is not a desirable solution, since this would impede the recognition and translation stages. The inventors then determined that a solution should preferably crop the or each full-resolution image frame to the smallest region of interest (ROI) containing the whole target, without processing the balance of image data in the or each frame. The inventors then realised that a low-powered, low-resolution ranging sensor could usefully detect targets in discrete portions of a substantially similar field of view as the device's camera(s), with which to identify corresponding portions of interest in the device camera's full-resolution image frames with minimal computational and power requirements.

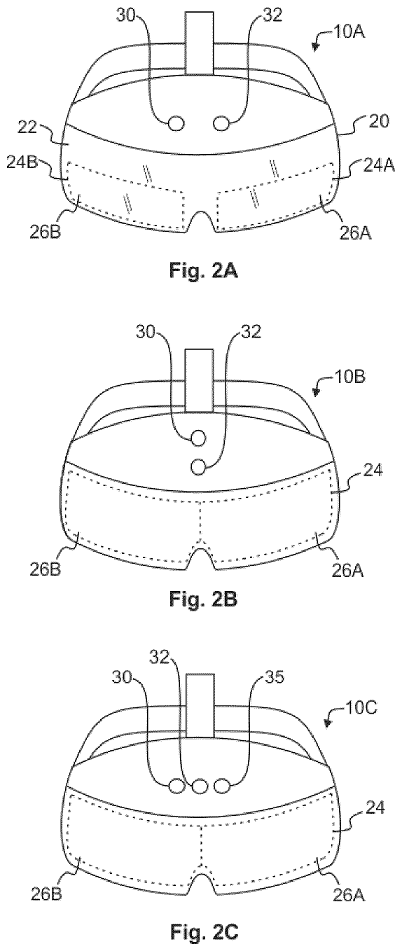

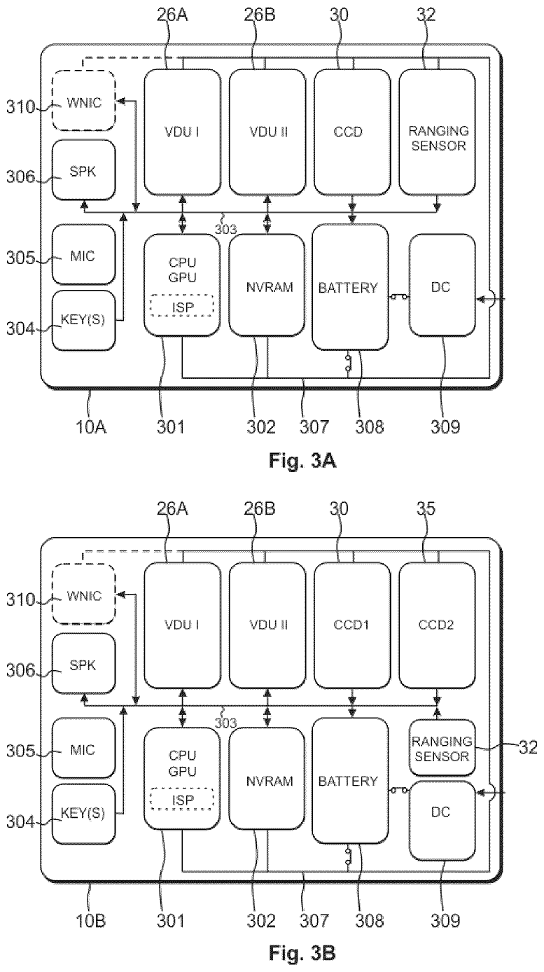

The inventive concept herein is capable of embodiment in a wide variety of data processing devices, and is expected to be of particular relevance to portable or wearable devices that are powered with an onboard power source and operate untethered from substantial computing resources, such as a desktop computer. Accordingly several example embodiments of a portable head mounted display (‘HMD’) device are illustrated in FIGS. 2A to 3B, wherein like numerals reference like features, by way of non-limitative examples.

A first embodiment shown in FIG. 2A is a HMD 10A of the same augmented reality (‘AR’) type, as was illustrated in FIG. 1. The HMD 10A again comprises a wearer visor 20 with a main see-though portion 22 and eye-respective video display portions 24A, 24B consisting of video display units 26A, 26B each with a resolution of 1920×1080 pixels, located proximate a lower edge of the visor so as to leave the see-though portion 22 extending above it up to its upper edge, clear of visual occlusion when the VDUs are displaying. The technical principles disclosed herein may implemented in other HMD types, such as a virtual reality (‘VR’) or mixed reality (‘MR’) closed display device 10B shown in FIG. 2B, wherein the eye-respective video display portions 24A, 24B implement, perceptually, a single video display portion 24 occupying substantially the whole inner front aspect of the HMD. For such HMDs, each video display portion 24A, 24B may consist of a RGB low persistence panel 26A, 26B with a minimum 60 Hz frame refresh rate and an individual resolution of 2048×1080 pixels per eye, for a perceived single video display with a resolution of 4096×2160 pixels.

Each HMD embodiment 10A, 10B further comprises at least one high-resolution or full-resolution optical sensor 30 with a respective field of view (FoV) 40 of, typically, 70 to 90 degrees, which captures the environment ambient the HMD visible in the FoV as visible light in a wavelength range of, typically, 400 to 700 nm, in the example a surgery room wherein an HMD wearer 36 points a finger 38 towards a patient lying atop an examination table. The imaging sensor 30 outputs image data 400 as a stream of RGB image frames 410 at a rate of 60 frames per second or more, either permanently or selectively according to the embodiment. Each image frame 400 has a resolution of at least 1920×1080 pixels in the case of AR HMD 10A, or at least 2048×1080 pixels in the case of VR/MR HMD 10B.

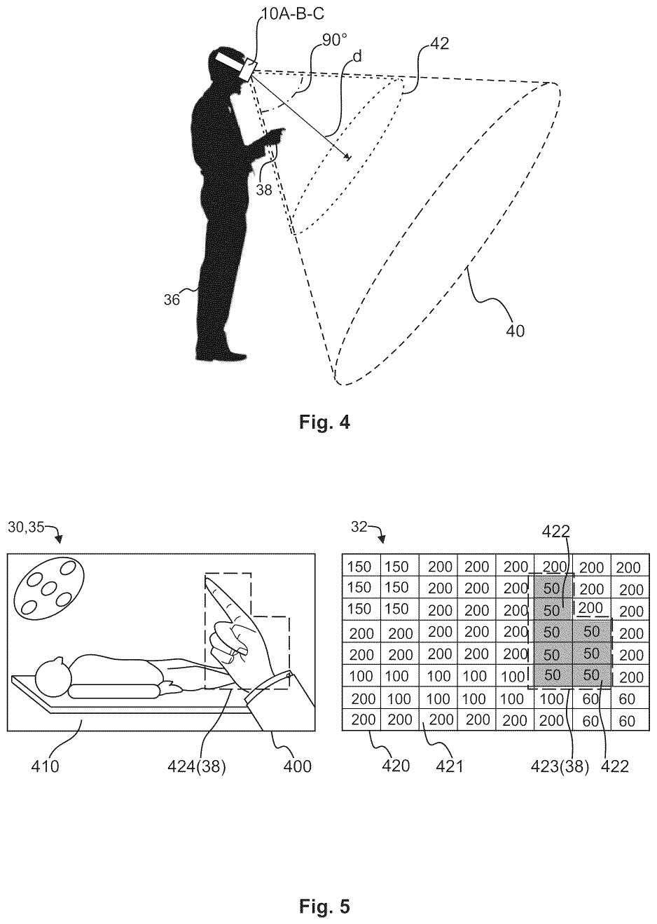

Each HMD according to the invention further comprises at least one low-resolution ranging sensor 32, with a respective field of view (FoV) 42 similar to the FoV 40 of the imaging sensor 30, i.e. of 70 to 90 degrees and coinciding substantially therewith, as illustrated in FIG. 4. The low-resolution ranging sensor continuously or periodically polls the same environment ambient the HMD, as is visible in the imaging sensor FoV 40, for targets, however within a relatively short distance interval d from the HMD, in the range 10 to 400 centimetres wherein targets of interest, in the example a HMD wearer's hand 38, are expected to appear.

The low-resolution ranging sensor 32 is, by way of limitative example, a low-power multi-zone time of flight (ToF) sensor, which does not require any specific computing unit, as even a microcontroller can process its output data, including under a relatively high capture or polling rate of 60 Hz, for example a sensor model VL53L7CX as manufactured by STMicroelectronics N.V. of Geneva, Switzerland. The skilled person will understand that the present technique may be practiced with other types of low-resolution ranging sensors which, subject to their characteristics and capacities, may allow a selection-detection of target according to type and distance, and/or colour-based target detection as the dominant colour in the FoV 40 can be detected dynamically.

The ranging sensor 32 is configured to split the observed field of view 42 into a plurality of discrete zones, in the example 64 zones arranged as a matrix 420 of 8 by 8 cells 421, wherein the matrix is representative of the ranging sensor's low resolution. The aspect ratio of the matrix 420 is preferably identical to the aspect ratio of the image frame 410, whereby each cell 421 corresponds to a respective portion of the image data 400 in the image frame 410, measuring for instance 240×135 pixels for an image frame size of 1920×1080 pixels, or 256×135 pixels for am image frame size of 2048×1080 pixels.

Whenever detecting one or more targets 38 in its respective FoV 42 within the distance interval d, the ranging sensor 32 generates a value for each cell 421 representative of a characteristic of the target respectively detected in the cell, in the example a distance between the ranging sensor 32 and targets within its FoV 42 since the ranging sensor 32 is a ToF sensor. By reference to the example scene depicted in FIG. 5, the hand with finger 38 is located approximately 50 centimetres from the sensor 32 wherein cells corresponding to same within the FoV 42 are assigned a distance value of ‘50’, whereas e.g. the patient lying atop the examination table is located approximately 100 centimetres from the sensor 32 wherein cells corresponding to same within the FoV 42 are assigned a distance value of ‘100’.

The ranging sensor 32 then outputs target data 422 consisting of the characteristic for each detected target across the matrix 420. In the example the output target data 422 accordingly comprises a respective cell identifier and a respective distance to a detected target for each cell 421, encoding both the distance and matrix location of each target detected within the FoV 42. Accordingly, subject to the size of a target and to its proximity to the ranging sensor, a target may be defined by plurality of adjoining cells 421 constituting a cluster 423. By reference to the identity of aspect ratio between an image frame 410 and the ranging sensor detection matrix 420, the periphery of each cell 421, or of the cluster 423 of a plurality thereof, with a state representing a valid detection of a target according to principles described hereafter, defines and bounds a corresponding portion 424 of image data 400 in the image frame 410, in which the or each detected target 38 is, or can be, captured at full resolution by the imaging sensor 30.

Embodiments of the HMD according to the invention may include further sensors, for example a further high resolution or full resolution optical sensor 35 as shown in the VR/MR HMD embodiment 10C shown in FIG. 2C, identical to the first sensor 30 for providing a stereoscopic capture of the ambient physical environment with visual depth information. In further embodiments considered advantageous for surgical use, the further optical sensor 35 may capture light within a different spectrum relative to the first sensor 30 instead, for example in the wavelength range 800 to 2,500 nm corresponding to near infrared (‘NIR’) light, whereby the wearer may observe aspects of a subject made fluorescent by a NIR imaging contrast agent.

All embodiments of a HMD according to the invention further comprise a data processing capacity and, optionally, a data connectivity capacity. Example hardware architectures for HMDs 10A and 10C are next described in further detail with specific reference to, respectively, FIGS. 3A and 3B, wherein like numerals still reference like features, by way of non-limitative examples.

In addition to sensors 30, 32 and optionally 35, each HMD 10A, 10B, 10C includes a data processing unit 301, which is a general-purpose microprocessor, for instance according to the Cortex™ architecture manufactured by ARM™, acting as the main controller of the HMD. The CPU 301 may further include a dedicated image signal processing (‘ISP’) unit or module to receive and pre-process image data generated by the optical sensor 30 before outputting the corresponding image data to the CPU 301. When present, this ISP unit is either integral or coexists with the CPU 301, that is programmed to perform other data processing tasks described hereafter. The CPU 301 is coupled with memory means 302, comprising volatile random-access memory (RAM), non-volatile random-access memory (NVRAM) or a combination thereof. by a data input/output bus 303, over which they communicate and to which the other components of the HMD 10 are similarly connected, in order to provide headset functionality and receive user commands.

The data connection between the full-resolution imaging sensor(s) 30, 35 and the CPU 301 via the bus 303 or another, is a high-frequency data communication interface which is sensitive to external electromagnetic interference (EMI) and must be shielded accordingly. The data connection between the ranging sensor 32 and the CPU 301 via the bus 303 or another, is a low-frequency data communication interface, for instance according to the I²C protocol, wherein any EMI over that interface is negligible considering the data type and volume output by the ranging sensor.

User input data may be received directly from a physical input interface 304, which may be one or more buttons, including at least an on/off switch, and/or a portion of the HMD casing configured for haptic interaction with a wearer's touch. User input data may also be received indirectly, such as gestures captured optically by the optical sensor(s) 30 and/or spoken words captured as analogue sound wave data by a microphone 305, for which the CPU 301 (or a DSP unit or module, not shown) implements an analogue-to-digital converting function, both of which the CPU 301 then interprets according to principles already introduced herein, that are outside the scope of the present disclosure. Processed audio data is output to a speaker unit 306, and power is supplied to all components by an electrical circuit 307, which is interfaced with an internal battery module 308, wherein the battery is periodically recharged by an electrical converter 309.

At any specific time at runtime, data circulating within the example architecture includes one or more of target data 422 whenever output by the ranging sensor 32 according to the principles described herein, image data 400 whenever generated by the imaging sensor(s) 30, display data output by the CPU 301 to the display units 26A, 26B and processed audio data output to a speaker unit 306. Power is supplied to the above components by an electrical circuit 307, which is interfaced with an internal battery module 308, wherein the battery is periodically recharged by an electrical converter 309.

Embodiments of the HMD according to the invention may further include networking means 310, shown in dotted line in the figure as a wireless network interface card or module (WNIC) also connected to the data input/output bus 303 and the electrical circuit 307, apt to interface the HMD with a wireless local area network (‘WLAN’) generated by a local wireless router. Alternative or additional wireless data communication functionality may be provided by the same or another module, for example implementing a short-range data communication according to the Bluetooth™ and/or Near Field Communication (NFC) interoperability and data communication protocol.

In a computing context, the processing required for conventional target detection as described with reference to FIG. 1 typically resides in higher computing layers, e.g. at the application level, which is advantageous for processing operations involving complex models, but requires significant computational resources and power draw. The present invention improves this technique by displacing the operational requirement to detect targets and crop full-resolution image frames 400 into portion(s) 424 with target(s) of interest, to a lower computing layer, at the OS-kernel level, with significant relief on computing and power resources. This is made possible by the low-frequency interface of the low-power depth sensor 32 to the CPU 301, recalling that as simple a data processing unit as a microcontroller, could process the sensed data and output same into that interface onwards to the CPU.

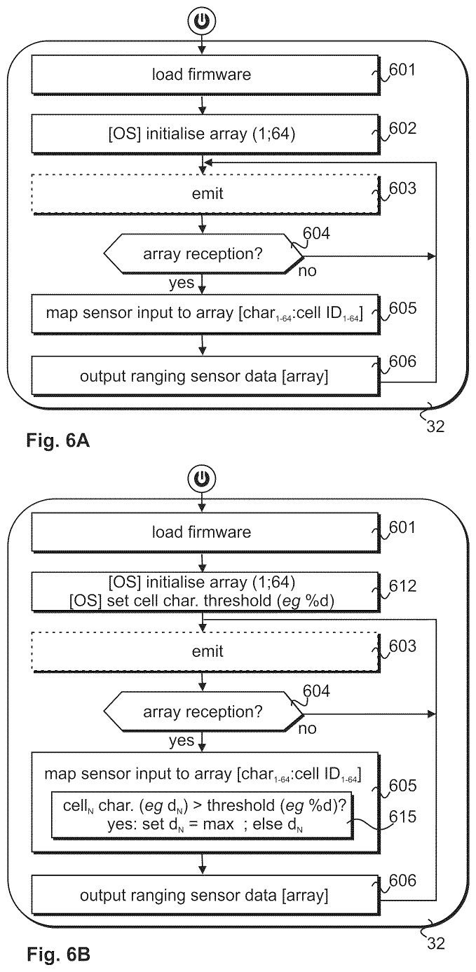

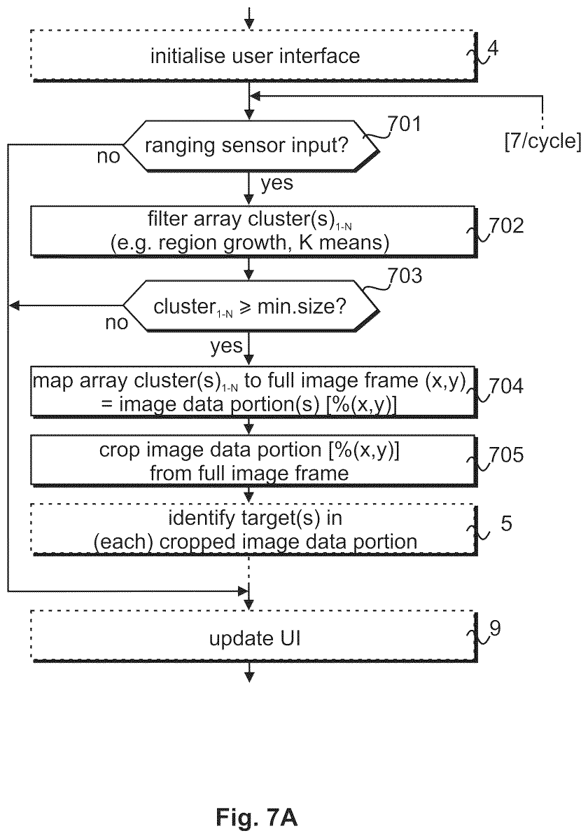

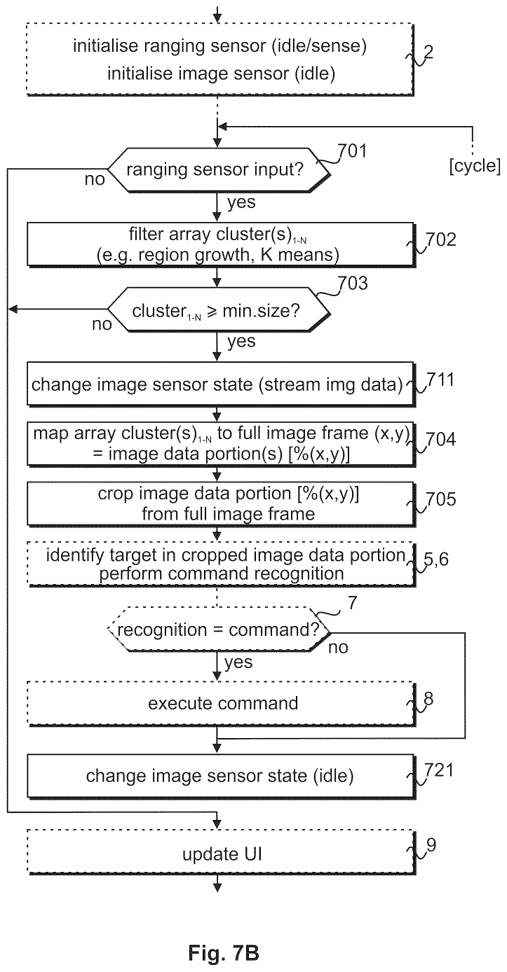

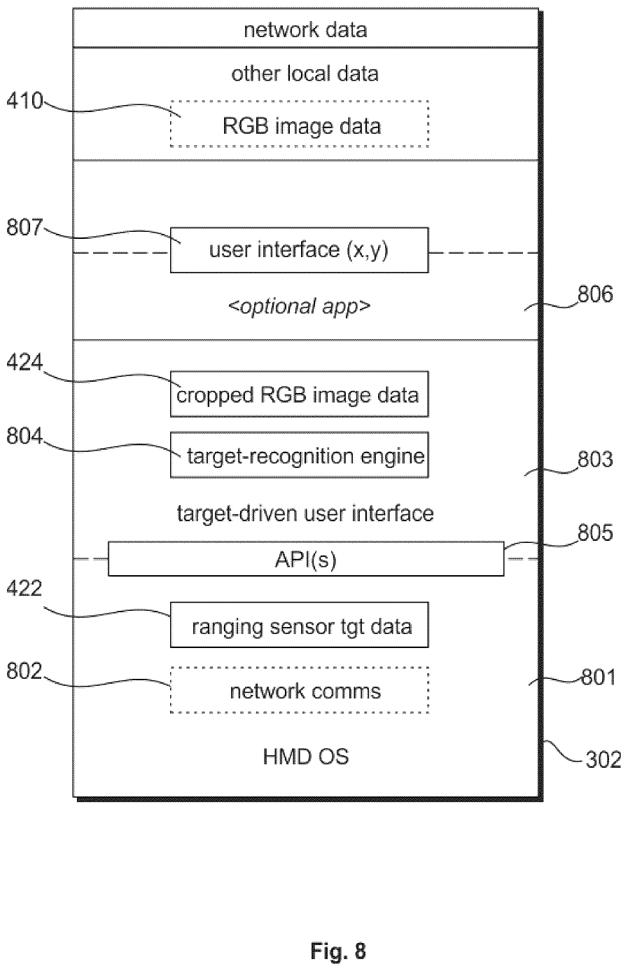

Accordingly basic and enhanced data processing configurations and functionality of a HMD 10A, 10B, 10C of FIGS. 2A to 5 is now described by reference to FIGS. 6A to 7B, wherein data structures stored in the memory 302 and processed by the CPU 301 are shown in FIG. 8 and wherein like numerals reference likes features.

In a first embodiment of an operational mode of the ranging sensor 32 shown in FIG. 6A, upon powering up the HMD the sensor loads a discrete set of operating instructions, i.e. a sensor firmware, at step 601 with which it initialises the detection matrix 420 at step 602. Subject to the type of ranging sensor used, the sensor may optionally begin to emit a signal, for example a light wave, at step 603 for illuminating target(s) within its FoV 42 to trigger a detection. A question is then asked at step 604, about whether one or more of its zones 421 has been triggered, representative of a detection within the FoV42. In the negative, control returns to the optional emitting of step 603, alternatively in the absence of any emission the sensor 32 executes a wait instruction then resumes the polling of question 604. The question of step 604 is eventually answered positively and, at the next step 605, the sensor processes the detection event with determining the characteristic value for the respective cell 421 involved by the detection event, and mapping the determined characteristic to the cell 421 within the matrix 420, in the example of FIG. 5 the distance from the sensor 32 to the HMD wearer's hand 38, or to the patient lying atop the table, or to the operating theatre lamp, all present within its FoV 42. The sensor 32 then outputs target data 422 corresponding to the matrix 420 to the CPU 301, alternatively to the ISP when present, at step 606 and control again returns to the optional emitting of step 603, alternatively the question of step 604.

In a second embodiment of an operational mode of the ranging sensor 32 shown in FIG. 6B, wherein like reference numerals reference like data processing steps, the sensor firmware implements user adjustment for the characteristic of a detectable target, for example a proximity threshold representative of a shorter distance to the sensor than the distance interval d, consisting of a minimum or maximum value for the distance value assignable to a cell 421 by the sensor or, in the case of a ranging sensor 32 with a signal-emitting capacity, a settable signal strength value.

Accordingly, upon powering up the HMD the sensor again loads its firmware at step 601, with which it initialises the detection matrix 420 and, in this embodiment, a target characteristic threshold at step 612, which a user may input at start-up or in a start-up configuration file during a preceding runtime instance. Control proceeds to the optional emitting of step 603, alternatively to the detection question of step 604. When answered negatively, control returns to the optional emitting of step 603, alternatively the sensor 32 waits then resumes the polling of question 604. When the question of step 604 is eventually answered positively the sensor processes the detection event at the next step 605 and, in this embodiment, the mapping of the determined characteristic to the cell 421 within the matrix 420 is filtered at sub-step 615, by comparing that determined characteristic against the target characteristic threshold of step 612 and setting the characteristic value for the cell to a maximum permissible value whenever the detected value exceeds the target characteristic threshold.

In the example, the sensor accordingly filters the detection event by generating the distance value for the or each cell involved by the detection event, comparing each cell's distance value against the proximity threshold value, mapping distance values under the proximity threshold to their respective cells and mapping a maximum distance value to other cells, the respective distance values of which exceed the proximity threshold. The sensor 32 then outputs the target data 422 to the CPU 301 at step 606 and control again returns to the optional emitting of step 603, alternatively the question of step 604.

The ranging sensor 32 remains operative independently of the CPU 301 activity and tasks whilever the HMD remains in use, and its firmware may implement additional functionality, notably a switching between active and idle states according to preset periods of non-detection, for enhanced power conservation and irrespective of the embodiment of operational mode. A first embodiment of an operational mode of the HMD is shown in FIG. 7A, based upon the detecting and target data outputting of the ranging sensor 32 irrespective of its operational mode, by reference to the prior art technique of FIG. 1 wherein like numerals reference like data processing steps.

When powering up the HMD 10A, an operating system (‘OS’) 801 is again initially loaded at step 1, for governing basic data processing, interdependence and interoperability of HMD components 301 to 309, including the WNIC 310 when present. The HMD OS may be based on Android™ distributed by Google™ of Mountain View, California, United States. The OS 801 includes subroutines for reading and processing input and output data, optionally including subroutines 802 to configure the HMD 10A for bilateral network communication with remote terminals via the WNIC 310 interfacing with a network router device.

Still at step 1, a set of instructions 803 embodying a target recognition-driven human-machine user interface 803, in the example a gestural user interface application, is loaded either as a subroutine of the OS 801 or as a distinct application in a higher computational layer, wherein the distinction is shown as a dotted line in FIG. 8. The application 803 comprises a target recognition engine 804, for instance a trained model as previously discussed herein, and is interfaced with the optical sensor(s) 30, 35 and the low resolution ranging sensor 32 through the OS 601 via one or more Application Programmer Interfaces (API) 805.

Further to the initialising of the imaging sensor 30 at step 2, to the optional loading of an application program 806 at step 3 and to the initialising of a user interface 807 of the OS 801 or that optional application 806 program at step 4, and as the ranging sensor has been initialised according to steps 601, 602 in parallel to or as part of step 1 and eventually begins to output target data 422 at step 606, a question is initially asked at step 701, about whether such target data 422 is being received at the CPU 301, alternatively at the ISP, over the low frequency data connection.

In the affirmative, the CPU 301 or ISP validates the presence of a detected target 38 of interest in the received target data at step 702, by filtering out redundant target data based on a comparison of the characteristics encoded in the target data 422, in the example the respective distance value of each cell 421, against a target detection threshold, for instance a maximum distance for a HMD wearer's hand relative to the ranging sensor 32, e.g. set to 50 centimetres. Cells with a distance value found to exceed the target detection threshold are excluded from further analysis. For cells remaining after the initial filtration, their identifiers 421 also encoded in the target data 422 are input to a clustering analysis, for instance implemented with a Region Growth or K Means technique, which outputs one or more cluster(s) 423 of cells 421, each now deemed to contain a detected target 38 of interest.

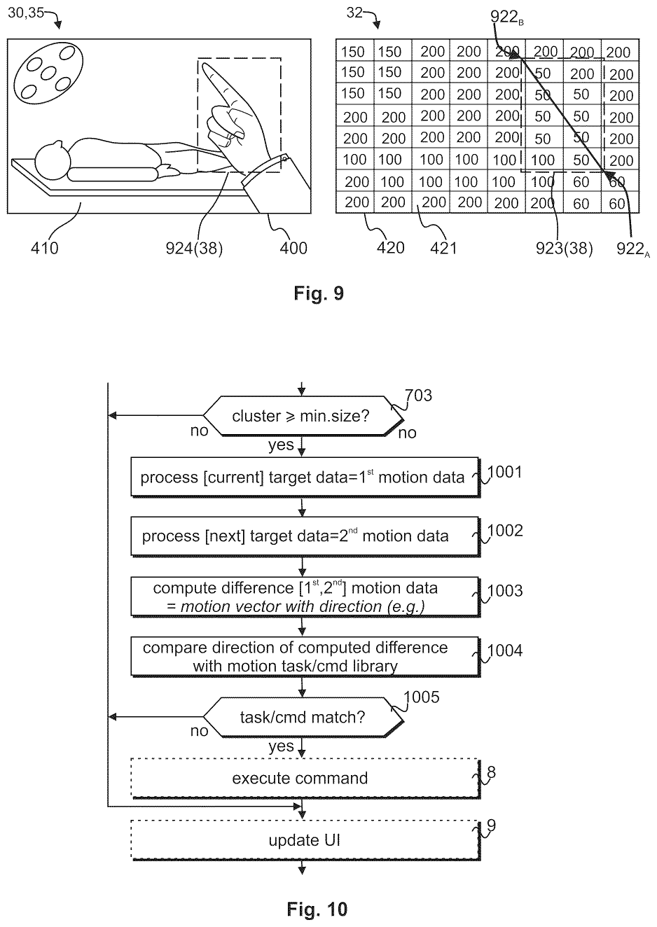

Alternatively the filtration may be implemented with a points-based interpolation technique, illustrated in FIG. 9 wherein like numerals reference likes features, for instance with selecting points at opposed corners, e.g. bottom right 922_{A} and top left 922_{B}, of the cluster 923 defined by the collection of cell identifiers 421 with matching characteristics, which still defines and bounds a corresponding portion 924 of image data 400 in the image frame 410, in which the or each detected target 38 is, or can be, captured at full resolution by the imaging sensor 30. This step advantageously mitigates any false positive detections at or near the edge of the distance interval d, for example when target data should encode merely a pair of contiguous cells 421, to prevent redundant processing of image data according to later steps of the logic.

A question is accordingly asked at step 703, about whether the comparison computed at step 702 is indicative of a detected target, e.g. a user's hand 38 within the distance interval d. In the affirmative, the CPU 301 or its ISP maps each cell 421, of known equivalent dimensions in the image frame 410, contained in the or each cluster 423 to the image frame 410 and thus determines the or each corresponding portion 424 of image data 400 as a respective region of interest within the full-resolution image frame 410 at step 704. The CPU 301 or its IPS then crops the image frame 410 down to the or each computed region of interest 424 at step 705.

The cropped image data 424 generated at step 705 is then input to the conventional target detection algorithm, wherein the or each portion 424 of high resolution image frame 410 is traversed by the algorithm to identify a portion-respective target therein, i.e. the hand 38 with pointing finger of the HMD wearer 36 at step 5. The conventional recognition data processing occurs as described hereinbefore until the HMD updates the user interface at step 9, to which control proceeds directly whenever the question of either step 701 or step 703 is answered negatively, and control eventually returns to the target data polling question of step 701, and so on and so forth until the HMD should be powered down.

In the first embodiment described above, the imaging sensor 30 is continuously capturing the environment ambient the HMD after initialisations of step 3, whereby the data processing steps 701 to 705 based upon the target data from the ranging sensor usefully spare the computational overhead associated with performing optical target recognition from, and in, full-resolution image frames 410. A second embodiment of an operational mode of the HMD is shown in FIG. 7B, wherein like numerals reference like data processing steps of FIGS. 7A and 1, which is more power efficient.

This second embodiment implements selective switching of the imaging sensor(s) 30 35 between active and idle states, for enhanced power conservation and irrespective of the operational mode for the ranging sensor 32, wherein the or each imaging sensor is initialised at step 2 as before, however maintained in an idle state by default, so to not generate image frames 400, until and unless commanded by the CPU 301 or the ISP. Accordingly in this embodiment, when the question of step 703 is answered positively, the CPU 301 or ISP first switches the or each imaging sensor 30, 35 to an active state for generating image frames 400 at step 711, before proceeding to map cluster(s) to a first generated image frame at step 704.

The or each imaging sensor 30 remains in the active state and continues to capture image frames 400, so long as the conventional target detection algorithm continues to receive and process respective portions 424 of image frames generated at iterations of step 705, for interpreting the captured gesture into a command. The question of step 7 is eventually answered either positively, when a command is recognised, or negatively, for instance upon reaching a preset number of interpretation attempts from successive frame portions. In this embodiment, when the question of step 7 is answered positively, the CPU 301 executes the interpreted command at step 8 then switches the or each imaging sensor 30, 35 back to an idle state at step 721, to cease generating image frames. When the question of step 7 is answered negatively, the CPU 301 proceeds directly to the switching of step 721. Image data processing and corresponding power draw associated with all of generating the image data 400, transmitting it through the bus 303 and processing portion(s) of it for conventional target recognition, is thus made contingent upon a preliminary detection of at least one target 38 with the low resolution ranging sensor 32, and accordingly reduced further still relative to the first embodiment of FIG. 7A.

With reference to FIG. 10 now, an alternative embodiment is proposed which exploits a target pre-detection capacity of the ranging sensor 32 in the specific context of gestural user interfaces, by identifying an application command from a directional motion determined with the target data 422. That is, in a gestural user interface for which one or more directional motions of the user's e.g. hand(s) are known to be associated with respective specific data processing tasks or commands, filtered target data is analysed to determine whether the target 38 therein exhibits a relevant directional motion, prior to mapping the cluster 423, 923 to a corresponding portion 424, 924 of the image data, thus wherein the computational expense of the mapping and cropping steps 704, 705 and the processing of cropped high resolution data at steps 5 to 7 is avoided, as redundant.

In such embodiments, target data 422 is generated by the ranging sensor 32 per steps 601 to 606 as previously described with reference to FIG. 6A or 6B and output to, and filtered by, the CPU 301 per steps 701 to 703 as previously described with reference to FIG. 7A or 7B. Further to a positive answer to the question of step 703 however, at step 1001, the filtered target data current for the data processing cycle, or first filtered target data, is processed into first motion data, i.e. a motion start data point, according to the motion detection algorithm implemented for the embodiment and temporarily stored, e.g. buffered, until filtered target data for the next data processing cycle, or second filtered target data, is received on a subsequent iteration of question 703 being answered positively. The second filtered target data is likewise processed into second motion data, i.e. a motion end data point, at step 1002 and such motion start and end data points may be for instance respective centroids of the cluster 423 in successive captures by the ranging sensor 32.

At step 1003, a difference between the first and second motion data is computed, representative of a directional motion of the or each target 38. For example, a motion vector is computed with the first and motion start and end data points, the direction of which is determined by reference to the Cartesian plane of the matrix 420. At step 1004, the directional vector is compared with a library of application tasks and commands defined by a directional user input, for example “left for displaying next record” or “right for displaying previous record”, analogously to turning book pages. A question is accordingly asked at step 1005, about whether the comparison has identified a matching application task or command. When the question is answered positively, then the CPU 301 proceeds directly to execute the task or command according to step 8 as previously described, advantageously without any mapping nor high resolution image data cropping and recognition processing. Alternatively, the logic loops back to step 1001 to await and process a next instance of filtered target data.

Subject to the operational requirements of application(s) to control, the skilled person may devise an inexpensive wearable apparatus implementing the embodiment described with reference to FIG. 10, with an architecture simplified relative to those described with reference to FIGS. 3A and 3B, for instance comprising a CPU 301, memory 302, ranging sensor 32, associated data (303) and power (307,308,309) circuitry and a wired, or preferably wireless, data interface (e.g. 310) for relaying the determined directional motion data to a remote computer or the like that performs the corresponding data processing task or command.

Example embodiments have been described with a HMD wearer's hand(s) by way of target 38, but the principles disclosed herein are easily adapted and useable with alternative targets, such as medical markers or tags that are increasingly used as visual references for determining and tracking the position and/or orientation of patient, patient limb or treatment site relative to an HMD 10A, B, C in medical procedures, in particular surgery. As several markers may be placed at different, respective locations of a patient, the HMD wearer is expected to benefit from a segregation of marker(s) of interest according to distance relative to the HMD, pursuant to the principles disclosed herein, as markers come inside or fall outside the FoV 42 and distance interval d subject to how the HMD wearer changes position and/or orientation relative to the patient.

In such alternative embodiments, the respective configuration and logic of the ranging sensor 32 and the HMD 10A, B, C as described herein with reference to FIGS. 2A to 9 is substantially identical. The optional application 806 processes the cropped image data portion output at step 705 to identify the medical marker by way of target 38 as before, and to perform a further data processing task based on this recognition, at least to determine and maintain the alignment of the HMD coordinate system with that of the patient, limb or surgery site but also, for example, to calculate and adjust the position and/or orientation of computer-generated imagery composited onto an image of the patient (or, in the case of HMD10A, the patient directly observable) within in the HMD wearer's field of view 40, within the user interface 807.

The combination of ranging sensor with the method described herein accordingly optimises user machine interaction including machine commanding based upon a detection of proximate targets, typically user hands but also, and alternatively markers, tags and assorted other visual cues, even as simple as a particular colour.

In the specification the terms “comprise, comprises, comprised and comprising” or any variation thereof and the terms include, includes, included and including” or any variation thereof are considered to be totally interchangeable and they should all be afforded the widest possible interpretation and vice versa. The invention is not limited to the embodiments hereinbefore described but may be varied in both construction and detail.

1. A portable data processing apparatus comprising data processing means ;
at least one high-resolution imaging sensor, operable to capture an environment ambient the apparatus in a field of view as image data ;
a low-resolution ranging sensor, configured to detect one or more targets in the field of view within a distance interval of the apparatus and to output target data encoding a detected target characteristic ; and
power means connected to supply the imaging sensor, the ranging sensor and the data processing means, wherein the data processing means is configured to-receive
at least the target data from the low-resolution ranging sensor,
filter the received target data by comparing the detected target characteristic with a target detection threshold, and
map the filtered target data to a corresponding portion of the image data, when capturing the environment with the or each high-resolution imaging sensor.

2. The portable apparatus according to claim 1, wherein the detected target characteristic comprises a distance between the detected target and the low-resolution ranging sensor, and the target detection threshold comprises a proximity threshold.

3. The portable apparatus according to claim 2, wherein the proximity threshold is configurable as less than the distance interval, whereby the data processing means filters received target data only when at least a first target reaches the proximity threshold within the distance interval.

4. The portable apparatus according to claim 1, wherein the data processing means is further configured to receive the image data from the high-resolution imaging sensor and to crop the corresponding portion from the received image data.

5. The portable apparatus according to claim 1,
wherein the or each high-resolution imaging sensor is switchable and
wherein the ranging sensor is further configured to switch the or each imaging sensor to capture upon outputting the target data; or
wherein the data processing means is further configured to switch the or each imaging sensor to capture upon receiving the target data.

6. The portable apparatus according to claim 1, wherein the ranging sensor is configured to detect within the field of view into a plurality of discrete zones, whereby the target data further comprises a respective identifier of a or each zone.

7. The portable apparatus according to claim 6, wherein the ranging sensor is a low power time-of-flight (ToF) sensor operably connected to the data processing means via a low bandwidth data connection.

8. The portable apparatus according to claim 1, wherein the or each target is a human hand, the portion of the image data comprises image data representative of the or each human hand, and the data processing means is further configured to process either the portion of image data or the target data into a user command.

9. The portable apparatus according to claim 1, wherein the or each target is a medical marker or tag and the portion of the image data comprises image data representative of the or each medical marker or tag.

10. A method of detecting a target with a portable data processing apparatus, the portable apparatus comprising data processing means, at least one high-resolution imaging sensor operable to capture an environment ambient the apparatus in a field of view as image data, a low-resolution ranging sensor configured to detect one or more targets in the field of view within a distance interval of the apparatus, and power means operably connected to the imaging sensor, the ranging sensor and the data processing means, the method comprising the steps of
outputting target data encoding a detected target characteristic with the ranging sensor upon detecting the or each target;
receiving at least the target data at the data processing means;
filtering the received target data by comparing the detected target characteristic with a target detection threshold ; and
mapping the filtered target data to a corresponding portion of the image data, when capturing the environment with the or each high-resolution imaging sensor.

11. The method according to claim 10, wherein the detected target characteristic comprises a distance between the detected target and the low-resolution ranging sensor, and the target detection threshold comprises a proximity threshold.

12. The method according to claim 11, comprising the further step of configuring the proximity threshold to be less than the distance interval, wherein the step of filtering further comprises comparing the distance between the detected target and the low-resolution ranging sensor with the proximity threshold to filter out target data distal the proximity threshold.

13. The method according to claim 10 comprising the further steps of
capturing the environment with the high-resolution imaging sensor;
outputting the image data captured to the data processing means; and
cropping the image data to the mapped portion with the data processing means.

14. The method according to claim 10, wherein the high-resolution imaging sensor is switchable, the method comprising the further step of switching the high-resolution imaging sensor to capture image data either when target data is output by the low-resolution ranging sensor or when target data is received by the data processing means.

15. The method according to claim 10, wherein the step of outputting target data with the ranging sensor further comprises dividing the field of view into discrete zones at the ranging sensor, wherein the target data further comprises a respective identifier of a or each zone.

16. The method according to claim 11, wherein the or each target is a human hand, the corresponding portion comprises image data representative of the or each human hand, the method comprising the further step of processing the corresponding portion of image data, alternatively the filtered target data, into a user command with the data processing means.

17. The method according to claim 11, wherein the or each target is a medical marker or tag and the portion of the image data comprises image data representative of the or each medical marker or tag.

18. A wearable user interface apparatus comprising
data processing means having at least at least one output;
a low-resolution ranging sensor, operable to poll an environment ambient the apparatus in a field of view with a waveform signal, to detect one or more targets in the field of view within a distance interval of the apparatus according to the polling, and to output target data encoding a detected target characteristic; and
power storage means connected to supply the ranging sensor and the data processing means, wherein the data processing means is configured to-receive
at least the target data from the low-resolution ranging sensor ;
filter the received target data by comparing the detected target characteristic with a target detection threshold;
process first filtered target data into first motion data and second filtered target data into second motion data ;
compute a difference between the first and second motion data, representative of a directional motion of the or each target ; and
compare the computed difference against a library of data processing commands associated with respective directional motions to identify a matching data processing command.

19. A wearable user interface apparatus according to claim 18, wherein the distance interval is in the range 30 to 70 centimetres and wherein the or each target is a human hand.
